(19) United States
(12) Patent Application Publication
(10) Pub. No.: US 2026/0180175 A1
(43) Pub. Date: Jun. 25, 2026

(54) ANTENNA WITH AMPLITUDE MODULATION AND ASSOCIATED METHOD

(71) Applicant: THALES, Meudon (FR)

(72) Inventors: Per-Yann Le Roux, Toulouse (FR); Florian Alkhat, Toulouse (FR); Thierry Jean René Girard, Toulouse (FR)

(21) Appl. No.: 19/425,832

(22) Filed: Dec. 18, 2025

(30) Foreign Application Priority Data
Dec. 23, 2024 (FR) 24 15064

(51) Int. Cl. H01Q 3/36; H04B 7/0426

(52) U.S. Cl. CPC H01Q 3/36; H04B 7/0434

(57) ABSTRACT

The present disclosure relates to an antenna including a plurality of sources and a beamforming module connected to the sources. Each source includes a radiating element with a respective main radiation axis, whose inclination varies within the antenna. The beamforming module is capable of generating and applying an amplitude modulation law to the radiating elements depending on the beam to be formed. The amplitude modulation law comprises an amplitude modulation coefficient for each radiating element, so that each radiating element emits a signal that has a respective amplitude equal to a given amplitude modulated by the corresponding amplitude modulation coefficient or receives a signal having a respective amplitude, the corresponding amplitude modulation coefficient being applied to the respective amplitude after reception. The disclosure also relates to an associated method of use.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to an antenna comprising a plurality of sources, each source comprising a radiating element, each radiating element having a respective main radiation axis.

The antenna according to aspects of the disclosure is intended for use within a satellite constellation, such as in orbit around the surface of the Earth, strictly below the geostationary orbit.

The disclosure also relates to an associated method.

### Description of the Related Technology

The use of active antennas is known, in particular for making telecommunication constellations in the form of planar arrays. Each antenna element of the array has a radiation axis perpendicular to the plane of the array.

### SUMMARY OF CERTAIN INVENTIVE ASPECTS

The aim of aspects of this disclosure is to propose an antenna that limits the disadvantages presented above.

To this end, the disclosure relates to an antenna comprising a plurality of sources, each source comprising a radiating element, each radiating element having a respective main radiation axis, each respective main radiation axis having an inclination with a reference axis, the reference axis being common to the plurality of sources, the inclination of the respective main radiation axes varying within the antenna, the antenna comprising a beamforming module connected to the sources, the beamforming module being capable of controlling the radiating elements to form at least one beam,
characterized in that the beamforming module is capable of generating and applying an amplitude modulation law to the radiating elements, the amplitude modulation law depending on the beam(s) to be formed, the amplitude modulation law comprising an amplitude modulation coefficient for each radiating element, so that each radiating element emits a signal having a respective amplitude equal to a given amplitude modulated by the corresponding amplitude modulation coefficient or receives a signal having a respective amplitude, the corresponding amplitude modulation coefficient being applied to the respective amplitude after reception.

The amplitude modulation for each radiating element enables better control of the radiation pattern shape while limiting the squint phenomenon and the disadvantages of a planar antenna, whose radiation axes of the radiating elements are perpendicular to the planar array.

According to other advantageous aspects of the disclosure, the antenna comprises one or more of the following features, taken in isolation or in all technically possible combinations:
the radiating elements are arranged such that the main radiation axes are each tangent to a unique three-dimensional curve having a rotational symmetry around the reference axis, the three-dimensional curve presenting a polynomial function in any plane passing through the reference axis, or
the radiating elements are arranged so that each radiating element is an image by translation in parallel to the reference axis of a corresponding fictitious radiating element, the fictitious radiating elements being such that their main radiation axes are each tangent to a unique three-dimensional curve having a rotational symmetry around the reference axis, the three-dimensional curve presenting a polynomial function in any plane passing through the reference axis;
the beamforming module is capable of generating the amplitude modulation law according to the main direction of the beam(s) to be formed;
the beamforming module is capable of generating and applying a phase modulation law to the radiating elements, the phase modulation law depending on the beam(s) to be formed, the phase modulation law comprising a phase shift for each radiating element, so that each radiating element emits a signal that has the corresponding phase shift or receives a signal to which the phase shift is applied;
the beamforming module is digital;
the antenna is capable of generating a beam that has a frequency of between 1 GHz and 44 GHz; and/or
the antenna comprises a plurality of connectors, each connector connecting a respective source to a module, the sources and connectors being made by additive manufacturing.

The disclosure also relates to a method of using an antenna as defined above, comprising the following steps:
generation of an amplitude modulation law by the beamforming module, to form at least one beam,
emission or reception of a signal by the radiating elements, and
application of the generated amplitude modulation law to the signal received or to be emitted by the radiating elements.

According to other advantageous aspects of the disclosure, the method comprises one or more of the following features, taken in isolation or in all technically possible combinations:
the method of use comprises the generation of a phase modulation law by the beamforming module to form the at least one beam, and the application of the corresponding phase shift to the signal received or emitted by each radiating element; and/or
a plurality of beams are formed simultaneously, the generated amplitude modulation law corresponding to the superposition of amplitude modulation sub-laws to form each beam.

### BRIEF DESCRIPTION OF THE DRAWINGS

The disclosure will appear more clearly upon reading the following description, given solely by way of non-limiting example, and made with reference to the drawings wherein:

FIG. 1 is a schematic representation of an example of an antenna according to one embodiment of the disclosure.

FIG. 2 is a three-dimensional view of a first example of an arrangement of radiating elements of an antenna according to one embodiment of the disclosure.

FIG. 3 is a three-dimensional view of a second example of an arrangement of radiating elements of an antenna according to one embodiment of the disclosure.

FIG. 4 is a three-dimensional representation of an example of areas of an amplitude modulation law for the formation of an example of a beam.

FIG. 5 is a schematic view of an example of a beamforming module of an antenna according to one embodiment of the disclosure.

### DETAILED DESCRIPTION

The use of active antennas is known, in particular for making telecommunication constellations in the form of planar arrays. Each antenna element of the array has a radiation axis perpendicular to the plane of the array.

However, such antennas have several disadvantages.

To cover a wide field of view in low Earth orbit with such an active antenna, the size of the source is generally limited to a dimension of about 0.6 times the wavelength. In reception, for the Ka band and a frequency of between 27.5 GHz and 31 GHz, this means that the source is about 6 mm in size. Creating sources of such a dimension that have satisfactory performance, and can be industrialized, is complex.

Moreover, to minimize potential losses between an amplifier and the radiating element, it is preferable to provide the possible amplification chain as close as possible to the radiating element, so that the small dimension of the sources arranged in such a network complicates the making of the amplification chain.

Furthermore, an antenna comprising a network of closely spaced radiating elements has a higher risk of having an active standing wave ratio. This may then create directions of blindness, in which a destructive recombination of the patterns degrades directivity. The finer the network mesh, the greater the risk of encountering this phenomenon.

Moreover, such a planar antenna has its directivity optimum in its axis perpendicular to the plane. The greater the beam pointing angle, the worse the directivity. A loss of about-3 dB is typically encountered at the edge of coverage. This is particularly problematic in the case of low or medium Earth orbit constellations, as the smallest terminals are often flat antennas that perform worse at a low user elevation. Finally, from the perspective of the satellite, the greater the pointing angle, the larger the area covered by the beam. With a planar antenna, the worst performances are therefore above the largest areas and thus where there are potentially the most users.

Finally, to point a beam in a certain direction, the standard method is to apply a phase law to the array. However, with the law being calculated for a given frequency, it is observed that the beam no longer points where it should at the band edge, and performance in the direction of interest is then degraded; this phenomenon is called squint.

Document US 2013/0234890 A1 describes an antenna system having an array of antenna elements in which each antenna element is switchable between a plurality of phase states.

However, such an antenna system does not enable precise control of the radiation pattern shape. Moreover, it is sensitive to the squint phenomenon.

Aspects of the disclosure relate to an antenna.

The antenna is adapted for use on the surface of the Earth, for example, mounted on an aircraft, or used in space for telecommunications or radar, for example.

The antenna is capable of generating a beam that has a frequency of between 1 GHz and 44 GHz.

The antenna is adapted for use in reception mode or in emission mode, for example, or in emission/reception mode.

Preferably, the antenna is adapted for use in reception mode.

Such an antenna is particularly advantageous for covering a wide angular domain, especially with multiple beams.

The antenna is a satellite antenna in an orbit around the surface of the Earth, strictly below the geostationary orbit, for example.

The antenna has an angular domain of greater than or equal to +50° in relation to an axis, for example.

Alternatively, the antenna is used on the surface of the Earth, to track multiple satellites at elevations from 10°, for example.

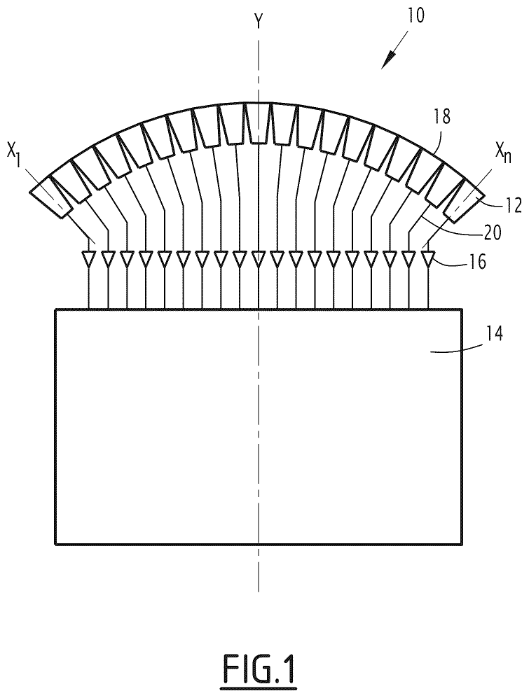

An example of an antenna 10 according to aspects of the disclosure is shown in FIG. 1.

The antenna 10 comprises a plurality of sources 12 and a beamforming module 14.

The antenna 10 further comprises one amplification block 16 per source 12.

Each source 12 is connected to the beamforming module 14, via the respective amplification block 16, for example.

The sources 12 together form an antenna array.

The antenna array has a mesh, the mesh being between 0.6 and 1.4 times a nominal wavelength of the antenna. The nominal wavelength of the antenna corresponds to a preferential operating wavelength of the antenna, of between 1 GHz and 44 GHz, for example.

One source is arranged in each mesh of the array.

The antenna 10 comprises between 128 and 512 sources, for example.

Each source 12 is made of metal, for example, such as aluminum here.

Each source 12 comprises a radiating element.

Each source 12 comprises a polarizer and possibly an additional filter, for example.

Each radiating element is capable of presenting a radiation at a front face 18 of the source.

Each radiating element is of a horn type, for example, circular, for example. Alternatively, the radiating elements are of a dipole, patch or helical type.

The radiating elements have different sizes within the antenna, for example.

Alternatively, the radiating elements all have the same size.

Each radiating element has a respective main radiation axis X1 . . . . Xn.

Each respective main radiation axis X1 . . . . Xn has an inclination with a reference axis Y.

The reference axis Y is common to the plurality of sources.

Each main radiation axis X1 . . . . Xn forms an inclination angle with the respective reference axis Y.

The inclination of the respective main radiation axes X1 . . . . Xn varies within the antenna, meaning that the radiating elements do not all have the same inclination.

The arrangement of the radiating elements here has a rotational symmetry around the reference axis Y.

The radiating elements placed at equal distance from the reference axis Y have equal inclination angles, for example.

The values of the inclination angles depend on the distance between the radiating elements and the reference axis Y.

More particularly, the further the radiating element is from the reference axis, the higher the inclination angle value.

The inclination profile according to the distance from the reference axis here depends on the domain to be covered and the size of the area to be covered by the beam.

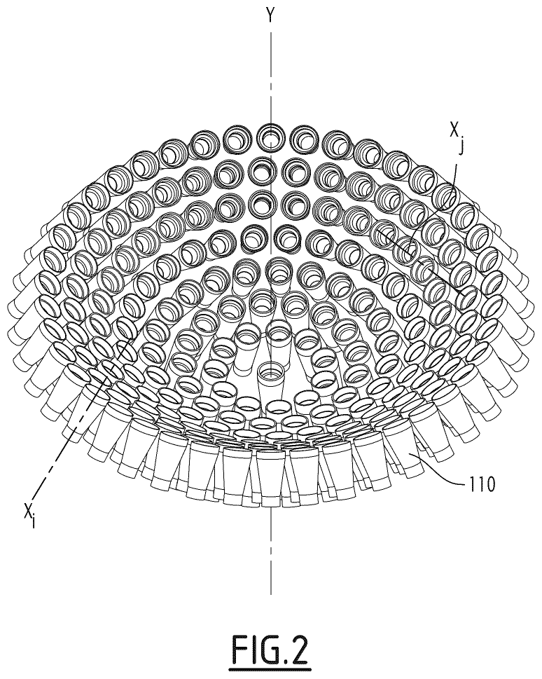

A first example of an arrangement of radiating elements of an antenna according to one embodiment of the disclosure is shown in FIG. 2.

The radiating elements 110 are arranged such that the main radiation axes Xi, Xj are each tangent to a unique three-dimensional curve.

The three-dimensional curve has a rotational symmetry around the reference axis Y.

The three-dimensional curve represents a polynomial function in any plane passing through the reference axis Y, for example.

More particularly, for any plane of space passing through the reference axis Y, there is a reference frame wherein the curve represents a function f of the form:

$$( x ) = {ax}^{n} + b , \qquad [ Math 1 ]$$

with a and b real numbers, a being non-zero and n a natural integer, more particularly an even natural integer.

The numbers a, b and n are chosen according to the use and desired performance of the antenna.

For each source, the intersection between the radiation axis Xi, Xj and the representative curve is defined as the radiation center of said source. Said radiation center is arranged within the corresponding radiating element.

Here, the radiating elements 110 are arranged so that their radiation axes Xi, Xj converge towards each other in front of the front face of the sources. Such an antenna is called a concave antenna.

Alternatively, the radiating elements 110 are arranged so that their radiation axes Xi, Xj diverge from each other at the level of the front face of the sources (as in FIG. 1). Such an antenna is called a convex antenna.

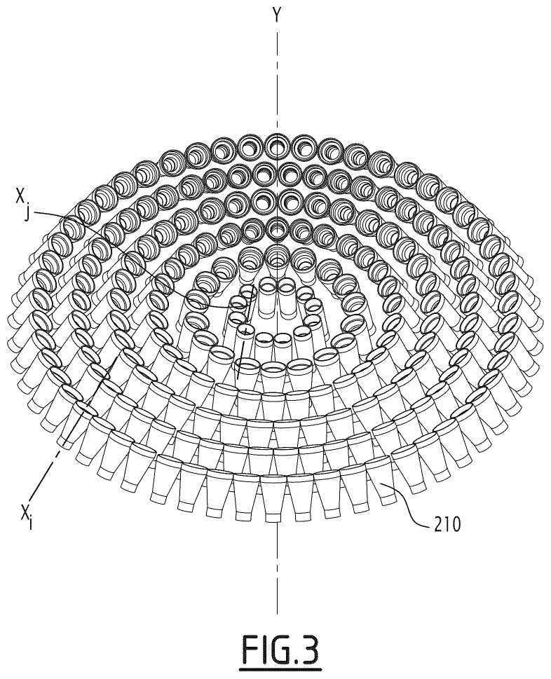

A second example of an arrangement of radiating elements 210 of an antenna according to an embodiment of the disclosure is shown in FIG. 3.

The radiating elements 210 are arranged so that each radiating element is an image by translation in parallel to the reference axis Y of a corresponding fictitious radiating element.

The inclination of each radiating element in relation to the reference axis Y is maintained by translation of the fictitious radiating element.

The fictitious radiating elements are such that their main radiation axes are each tangent to a unique three-dimensional curve.

The three-dimensional curve has a rotational symmetry around the reference axis.

The three-dimensional curve represents a function f: x->f (x) in any plane passing through the reference axis Y.

The three-dimensional curve represents a polynomial function in any plane passing through the reference axis Y, for example.

More particularly, for any plane of space passing through the reference axis, there is a reference frame wherein the curve represents a function f of the form:

$$( x ) = {ax}^{n} + b , \qquad [ Math 2 ]$$

with a and b real numbers, a being non-zero and n a natural integer, more particularly an even natural integer.

The numbers a, b and n are chosen according to the use and desired performance of the antenna.

The distance for each translation depends on the radiating element.

The respective translations of radiating elements placed at equal distance from the reference axis Y have an equal translation distance between them, for example.

The translation distance for each radiating element is equal to the absolute value of λf(x)+μ, for example, with λ a number between 0 and 1 and u a real number, k and μ each being a common number for all radiating elements, and f(x) the value of the representative curve function at the location of the corresponding fictitious radiating element.

The translation direction is such that the radiating elements are arranged on a three-dimensional curve image having a curvature radius locally that is strictly greater than the curvature radius of the three-dimensional curve at the level of the corresponding radiating element.

This enables reducing the height of the radiating element array, in particular, while retaining the advantages related to the inclination of the radiating elements. In particular, the performance, in terms of directivity of an antenna provided with such an arrangement of radiating elements, is similar to that of an antenna provided with the arrangement of radiating elements described with reference to FIG. 2.

The translation corresponds to a projection of each fictitious radiating element onto a reference plane, perpendicular to the reference axis Y, for example. The reference plane is common to all the radiating elements 210.

Here, the radiating elements 210 are arranged so that their radiation axes Xi, Xj converge towards each other in front of the front face of the sources. Such an antenna is called a concave antenna.

When the translations correspond to a projection of each fictitious radiating element onto a reference plane, it is more particularly called a concave planar antenna.

Alternatively, the radiating elements 210 are arranged so that their radiation axes Xi, Xj diverge from each other at the level of the front face of the sources. Such an antenna is called a convex antenna.

When the translations correspond to a projection of each fictitious radiating element onto a reference plane, it is more particularly called a convex planar antenna.

The polarizer is connected to the corresponding radiating element upstream, so that the polarization of the signal of the radiating element is adapted according to the polarizer.

The filter is connected to the corresponding polarizer upstream, to apply a filter to the frequency spectrum of the radiating element.

Each source 12 is connected to the beamforming module 14, via the respective amplification block 16, for example.

The antenna 10 comprises a plurality of connectors 20, called a deflector network.

Each connector 20 connects a respective source to a module, more particularly a respective module connected to the beamforming module 14, more particularly to the respective amplification block 16.

Each connector 20 is such that the connection distance between the beamforming module 14 and the radiating element of each source 12 is equal for all sources 12.

The sources 12 and connectors 20 are manufactured together, for example, by additive manufacturing, for example, more particularly in a metal such as aluminum.

Each amplification block 16 comprises at least one low-noise amplifier, more particularly one low-noise amplifier per polarization.

Each amplification block 16 is connected to the beamforming module 14.

Each amplification block 16 is configured to amplify a signal passing through it, going from the source 12 to the beamforming module 14 and/or from the beamforming module 14 to the source 12.

The beamforming module 14 is capable of controlling the signals coming from the radiating elements, in case of reception, or emitted by the radiating elements, in case of emission, to form at least one beam.

The beamforming module 14 is capable of generating and applying an amplitude modulation law to the signals coming from or emitted by the radiating elements, the amplitude modulation law depending on the beam(s) to be formed.

The amplitude modulation law comprises an amplitude modulation coefficient AA for each radiating element, so that each radiating element emits a signal that has a respective amplitude equal to a given amplitude modulated by the corresponding amplitude modulation coefficient, or receives a signal that has a respective amplitude, with the corresponding amplitude modulation coefficient being applied to the respective amplitude after reception.

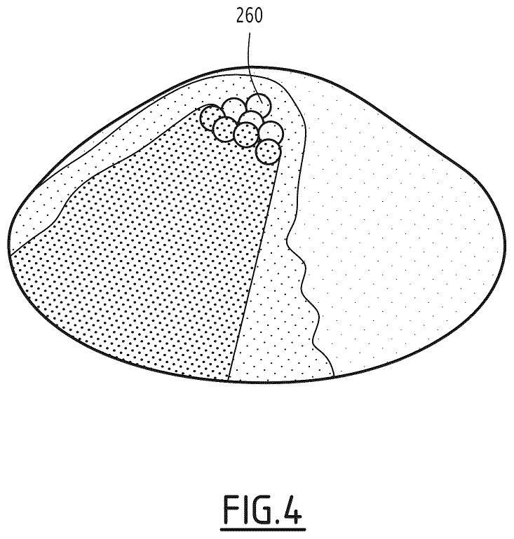

A representation of an example of areas of an amplitude modulation law is visible in FIG. 4.

Each radiating element is associated with an amplitude modulation coefficient.

In the representation of FIG. 4, each area relates to an interval of values for the amplitude modulation coefficient.

The radiating elements 260 of the same area are likely to have different amplitude modulation coefficients within the corresponding interval.

The higher the interval corresponds to high amplitude modulation coefficients; the higher the area is represented with a high point density.

In the represented example, a beam is to be formed, the beam being generally directed according to the inclination of the darkest radiating elements.

More particularly, in the reception mode of the antenna, each radiating element receives a signal that has a respective amplitude. For each radiating element, the amplitude modulation coefficient is applied to the corresponding received signal.

The application of the amplitude modulation coefficient is carried out by the beamforming module, as described below.

In the emission mode of the antenna, each radiating element emits a signal that has a respective amplitude equal to a given amplitude modulated by the corresponding amplitude modulation coefficient.

The amplitude modulation law depends on the main direction of the beam(s) to be formed, the size of the beam(s) to be formed and/or the purity of the beam(s) to be formed, for example, with the purity being the level of the secondary lobe.

If multiple beams are to be formed simultaneously in emission (or transmission), the generated amplitude modulation law corresponds to the superposition of amplitude modulation sub-laws to form each beam.

Furthermore, the beamforming module 14 is capable of generating and applying a phase modulation law to the signals coming from the radiating elements, for reception, or emitted towards the radiating elements, in emission, with the phase modulation law depending on the beam(s) to be formed.

The phase modulation law of a beam comprises a phase shift Δφ for each radiating element, so that, for said beams, each radiating element emits a signal that has the corresponding phase shift or receives a signal to which the phase shift is applied.

In relation to the amplitude modulation, the phase modulation law provides an additional degree for improving the pointing or formation precision of the beams.

The phase modulation law has a precision, i.e. a maximum increment between the different possible values, of less than or equal to 2°.

If multiple beams are to be formed simultaneously in emission (or transmission), the generated phase modulation law corresponds to the superposition of phase modulation sub-laws to form each beam.

More particularly, in the reception mode of the antenna, each radiating element receives a signal that has a respective phase. For each radiating element, the phase shift is applied to the corresponding received signal.

The application of the phase shift is carried out by the beamforming module.

In the emission mode of the antenna, each radiating element emits a signal that has the corresponding phase shift.

The beamforming module 14 is likely to be digital or analog.

Here, the beamforming module 14 is digital, for example.

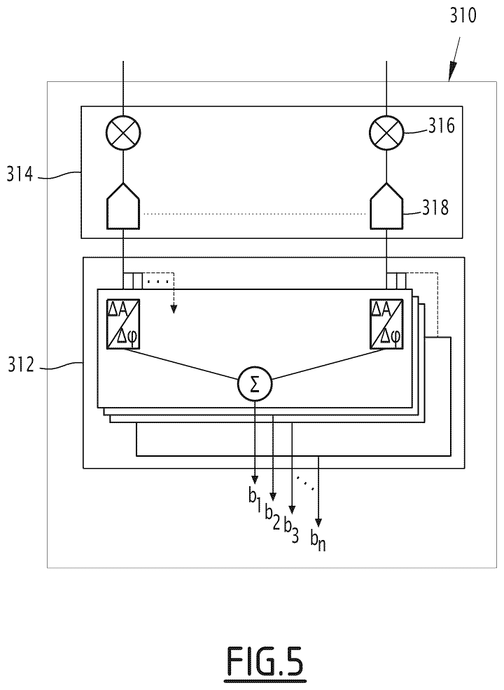

An example of a beamforming module 310 is shown in FIG. 5.

The beamforming module 310 comprises a processing sub-module 312, for example.

The beamforming module 310 comprises an addition conversion sub-module 314, for example.

Each source is connected to the processing sub-module 312, via the conversion sub-module 314, for example.

The conversion sub-module 314 comprises a frequency converter 316, for example, and/or an analog-to-digital converter 318, more particularly one frequency converter 316 and/or one analog-to-digital converter 318 per source.

The conversion sub-module 314 comprises one path per source here, with each path comprising a frequency converter 316 and/or an analog-to-digital converter 318.

Each path is connected via the amplification block to the corresponding source, at one end, and to the processing sub-module 312 at the other end, for example.

The frequency converter 316 and the analog-to-digital converter 318 are arranged in series.

The analog-to-digital converter 318 is arranged on the side of the processing sub-module 312 relative to the frequency converter.

Each source is connected to a respective frequency converter 316 and/or analog-to-digital converter 318, more particularly to a respective path.

The frequency converter 316 performs a direct frequency conversion, for example, more particularly in quadrature or I/Q.

The analog-to-digital converter 318 is capable of converting an analog signal from a source into a digital signal to the processing sub-module 312, more particularly in the reception mode of the antenna, and/or conversely, more particularly in the emission mode of the antenna.

The processing sub-module 312 is capable of generating the amplitude modulation law, and, if necessary, the phase modulation law, for each beam b1, b2, b3 . . . bn to be formed, applying the said laws to the received signal in reception, or alternatively to be generated in emission.

The processing sub-module 312 comprises an information processing unit, for example, formed of a memory and a processor associated with the memory, for example.

The processing sub-module 312 is implemented in the form of software, or a software module, executable by the processor. The memory is then capable of storing the software.

Alternatively, the processing sub-module 312 is implemented in the form of a programmable logic component, such as an FPGA (Field Programmable Gate Array), or an integrated circuit, such as an ASIC (Application Specific Integrated Circuit).

When the processing sub-module 312 is implemented in the form of one or more software programs, i.e. in the form of a computer program, also called a computer program product, it is also capable of being recorded on a medium, not shown, readable by a computer. The computer-readable medium is a medium capable of storing electronic instructions and being coupled to a computer system bus, for example. For example, the readable medium is an optical disk, a magneto-optical disk, a ROM memory, a RAM memory, any type of non-volatile memory (for example, FLASH or NVRAM), or a magnetic card. A computer program comprising software instructions is then stored on the readable medium.

The conversion sub-module 314 is connected to the processing sub-module 312.

In reception, the conversion sub-module 314 is capable of receiving the signals received by the sources, amplified and/or filtered, for example, digitizing them and transmitting them to the processing sub-module 312.

In reception, the processing sub-module 312 is capable of receiving the signals received by the sources, here converted by the conversion sub-module 314, applying the amplitude modulation law and the phase modulation law, if necessary, corresponding to the beam(s) to be formed.

In emission, the processing sub-module 312 is capable of generating the amplitude modulation law and the phase modulation law, if necessary, corresponding to the beam(s) to be formed, and emitting a corresponding signal to which the amplitude modulation law and the phase modulation law, if necessary, has been applied. The signal emitted by the processing sub-module 312 is emitted towards the sources, more particularly here to the conversion sub-module 314.

In emission, the conversion sub-module 314 is capable of receiving the signal emitted by the processing sub-module, converting it into an analog signal and transmitting it to the sources, here via an amplification block.

A method of using an antenna 10 according to aspects of the disclosure will now be described.

The method of use comprises the following steps:
generation of an amplitude modulation law by the beamforming module 14, to form at least one beam,
emission or reception of a signal by the radiating elements, and
application of the generated amplitude modulation law to the signal received or to be emitted by the radiating elements.

In addition, the method of use comprises the generation of a phase modulation law by the beamforming module to form the at least one beam, for example, and the application of the corresponding phase shift to the signal received or to be emitted by the radiating elements.

When a plurality of beams are formed simultaneously, the generated amplitude modulation law and the generated phase modulation law, if necessary, correspond(s) to the superposition of amplitude modulation sub-laws and phase modulation sub-laws, if necessary, to form each beam.

More particularly, in reception, the sources 12 receive a signal and transmit it to the beam generation module 14, via the amplification block 16, for example.

The beam generation module 14 applies the generated amplitude modulation law and the generated phase modulation law, if necessary, to the received signal.

More particularly, the conversion sub-module 314 receives the signal transmitted by the sources, amplified and/or filtered, for example, digitizes it and transmits it to the processing sub-module 312.

The processing sub-module 312 receives the signal transmitted by the sources, here converted by the conversion sub-module 314, and applies the amplitude modulation law and the phase modulation law, if necessary, corresponding to the beam(s) to be formed.

In emission, the beamforming module 14 generates the amplitude modulation law and the phase modulation law, if necessary, corresponding to the beam(s) to be formed, and transmits to the sources the signal to which the laws have been applied. Each source 12 then emits a signal with an amplitude to which the corresponding amplitude modulation coefficient is applied, with the corresponding phase shift, if necessary.

More particularly, the processing sub-module 312 generates the amplitude modulation law and the phase modulation law, if necessary, corresponding to the beam(s) to be formed, and emits a corresponding signal to which the amplitude modulation law and the phase modulation law, if necessary, has been applied.

The signal emitted by the processing sub-module 312 is emitted towards the sources, more particularly here to the conversion sub-module 314.

The conversion sub-module 314 receives the signal emitted by the processing sub-module, converts it into an analog signal and transmits it to each source, here via the corresponding amplification block.

Each source 12 then emits a radiation with an amplitude to which the corresponding amplitude modulation coefficient is applied, with the corresponding phase shift, if necessary.

An antenna according to aspects of the disclosure enables orienting the beam without performing an adapted phase shift to adjust the beam pointing. Indeed, the depointing is primarily achieved by activating the radiating elements of the array in amplitude differently. This avoids the disadvantages raised for a classic planar antenna array.

The mesh is likely to be widened without creating a network lobe, which enables having the same directivity for a reduced number of radiating elements, for example.

The conformation also enables having a larger surface in the desired direction. Thus, for a high elevation, the projection of the antenna surface enables greater directivity.

Finally, the fact of not applying a first-order phase shift law to orient the beam limits the squint effect at the band edge.

What is claimed is:

1. An antenna comprising a plurality of sources, each source comprising a radiating element, each radiating element having a respective main radiation axis, each respective main radiation axis having an inclination with a reference axis, the reference axis being common to the plurality of sources, the inclination of the respective main radiation axes varying within the antenna, the antenna comprising a beamforming module connected to the sources, the beamforming module being capable of controlling the radiating elements to form at least one beam,
wherein the beamforming module is capable of generating and applying an amplitude modulation law to the radiating elements, the amplitude modulation law depending on the beam(s) to be formed, the amplitude modulation law comprising an amplitude modulation coefficient for each radiating element, so that each radiating element emits a signal that has a respective amplitude equal to a given amplitude modulated by the corresponding amplitude modulation coefficient or receives a signal that has a respective amplitude, the corresponding amplitude modulation coefficient being applied to the respective amplitude after reception,
the antenna comprising a plurality of connectors, each connector connecting a respective source to a module, the sources and connectors being made by additive manufacturing.

2. The antenna according to claim 1, wherein the radiating elements are arranged such that the main radiation axes are each tangent to a unique three-dimensional curve that has a rotational symmetry around the reference axis, the three-dimensional curve representing a polynomial function in any plane passing through the reference axis, or
wherein the radiating elements are arranged so that each radiating element is an image by translation in parallel to the reference axis of a corresponding fictitious radiating element, the fictitious radiating elements being such that their main radiation axes are each tangent to a unique three-dimensional curve that has a rotational symmetry around the reference axis, the three-dimensional curve representing a polynomial function in any plane passing through the reference axis.

3. The antenna according to claim 1, wherein the beamforming module is capable of generating the amplitude modulation law based on the main direction of the beam(s) to be formed.

4. The antenna according to claim 1, wherein the beamforming module is capable of generating and applying a phase modulation law to the radiating elements, the phase modulation law depending on the beam(s) to be formed, the phase modulation law comprising a phase shift for each radiating element, so that each radiating element emits a signal that has the corresponding phase shift or receives a signal to which the phase shift is applied.

5. The antenna according to claim 1, wherein the beamforming module is digital.

6. The antenna according to claim 1, wherein the antenna is capable of generating a beam having a frequency of between 1 GHz and 44 GHz.

7. A method of using an antenna according to claim 1, comprising the following steps:
generation of an amplitude modulation law by the beamforming module, to form at least one beam,
emission or reception of a signal by the radiating elements, and
application of the generated amplitude modulation law to the signal received or to be emitted by the radiating elements.

8. The method of use according to claim 7, comprising the generation of a phase modulation law by the beamforming module to form the at least one beam, and the application of the corresponding phase shift to the signal received or emitted by each radiating element.

9. The method of use according to claim 7, wherein a plurality of beams are formed simultaneously, the generated amplitude modulation law corresponding to the superposition of amplitude modulation sub-laws to form each beam.
